(19) United States
(12) Patent Application Publication
(10) Pub. No.: US 2003/0183559 A1
(43) Pub. Date: Oct. 2, 2003

(54) Log handling apparatus and methods

(76) Inventor: Steven E. Hermann, Newport, WA (US)

Correspondence Address: Tom Olson, Reidlaw L.L.C., 1926 S. Valleyview Lane, Spokane, WA, 99212, US

(21) Appl. No.: 10/115,108

(22) Filed: Apr. 2, 2002

(51) Int. Cl. B07C 5/14

(52) U.S. Cl. 209/518

(57) ABSTRACT

Apparatus and methods for handling logs provide for the automatic accumulation of logs into separate groups within associated bins. Each group of logs preferably corresponds exclusively to a given set of log characteristics. When a predetermined quantity of logs has accumulated within a given bin, that group of logs can be released from the given bin for further processing, such as sawing. When the apparatus and methods incorporate a sawing apparatus or sawing operation, respectively, all of the logs within a given group can be sawn with the same sawing solution, wherein the gap between each successive log can be significantly reduced or eliminated, thus increasing the rate at which logs are sawn.

### FIELD OF THE INVENTION

The invention claimed and disclosed herein pertains to log handling apparatus and methods, and more particularly, to apparatus and methods for sorting and accumulating logs.

### BACKGROUND OF THE INVENTION

Prior art lumber production machinery includes sawing apparatus that are configured to saw logs into various lumber pieces. The number and/or size of the lumber pieces which can be efficiently sawn from a given log depend upon various characteristics of the given log. Such characteristics can include the diameter and length of the log, as well as other characteristics of the log, such as curvature, and cross-sectional shape, and the like. A plurality of other such characteristics can also be used as criteria for determining the number and sizes of the lumber pieces that can be sawn from the given log.

A specific “sawing solution” can be determined for a given log having characteristics that fall within a given range, wherein the sawing solution for the given log is the manner in which the given log is cut, or sawn, in order to maximize the utilization of the material in the given log. That is, the term “sawing solution” refers to the manner in which a given log is sawn into lumber pieces based on the characteristics of the given log, and whereby the amount of usable lumber produced from the given log is substantially maximized. Thus, a plurality of logs having various associated characteristics can generally be divided into a plurality of groups, wherein each group is exclusively associated with a respective sawing solution.

Usually, prior art sawing apparatus must be adjusted to a particular “setup” in order to perform a particular sawing solution. Thus, prior art sawing apparatus are configured to be changed between each of several different “setups,” wherein each setup corresponds to a given sawing solution. That is, prior art sawing apparatus are generally configured to be adjusted to one of a number of specific setups which will enable the sawing apparatus to efficiently perform a given sawing solution on a log. The capability of the sawing apparatus to be adjusted between each of several setups facilitates maximum efficiency in production of lumber because a single sawing apparatus is thus capable of sawing logs of varying characteristics in accordance with the respective applicable sawing solution.

As can be appreciated, the process of changing the setup of a prior art sawing apparatus is not instantaneous, and requires at least a minimum amount of time to perform, depending on the degree of automation incorporated into the sawing apparatus. Consequently, because a sawing apparatus generally cannot perform sawing operations during setup changes, sawing efficiency is increased if downtime due to setup changes is decreased. One approach for minimizing downtime of the sawing apparatus due to setup change is to pre-sort the logs into several groups prior to sawing, wherein logs of each group have the same sawing solution.

Furthermore, a general prior art practice in this regard is to accumulate sufficient numbers of logs so that pre-sorting of the logs results in groups of logs, wherein logs from a given group can be sawn during an entire production shift. That is, in accordance with one prior art practice, it is desirable to have sufficient quantities of logs on hand so that the sawing apparatus can be operated for an entire production shift without requiring a setup change. The sawing apparatus setup is thus generally changed between production shifts. This approach tends to maximize the utilization of the sawing apparatus, since the setup is generally changed only once for each production shift. That is, with such an approach, downtime of the sawing apparatus due to setup change is generally minimized.

However, on the other hand, such an approach of pre-sorting logs into groups of sufficient numbers, wherein a given group can be run throughout an entire production shift, requires the log pre-sorting operation to be performed on a relatively massive scale. That is, in view of the production rate capacity of current sawing apparatus, as well as the number of possible sawing apparatus setups and corresponding log groups, a relatively large proportion of resources must be devoted to such a log pre-sorting operation.

For example, for logs having an average nominal length of nine (9) feet and a diameter of between four (4) and ten (10) inches, a production rate of about 10,000 logs per work-shift per sawing apparatus is not uncommon with respect to current technology. Also, for example, around eighteen (18) different log groups, or sawing solutions, are generally employed in order to result in an acceptable level of optimization of lumber recovery in saw mills which process such logs. It is understood that production rates can differ depending on the length and diameter of the logs processed.

In view of the general level of production attainable by current sawing technology, as well as the general number of sawing solutions generally employed, it is appreciated that the proportion of resources, and particularly space, which would be required for a log pre-sorting operation is significant, to say the least. Furthermore, other problems can be associated with such pre-sorting operations.

For example, in order to minimize exposure of the sawing apparatus and other related apparatus to log yard contaminants (such as dirt and rocks), such pre-sorting operations are most preferably performed prior to log debarking and cleanup. Consequently, because bark thickness is neither constant, nor predictable, such log pre-sorting prior to debarking often leads to inaccurate detection and measurement of log characteristics. This, in turn, can lead to inaccurate categorization of the logs.

Such inaccurate categorization of logs due to pre-debarking measurements can result in various production problems. For example, as a result of performing measurements prior to bark removal, logs having one sawing solution are inevitably mixed with logs having another sawing solution. When a discovery of such an “out-of-place” log is made, the out-of-place log must be removed from the production line prior to entering the sawing apparatus, if the log is discovered in time. Alternatively, if such out-of-place logs are not discovered prior to entering the sawing apparatus, they are sawn using the wrong sawing solution, which leads to inefficient production. Furthermore, such out-of-place logs can jam in the sawing apparatus, resulting in excessive downtime.

Additionally, extensive utilization of mechanized heavy equipment, as well as extra labor, is necessary for handling of the logs in such pre-sorting operations, which further contributes to the proportion of resources that must be devoted to such operations. For example, large log-handling tractors and the like must be employed for moving the logs from place to place during the pre-sorting operation, and an extensive log bunker and conveyor system must usually be constructed and maintained.

An alternative to pre-sorting of logs has been developed in the prior art which aims to avoid the utilization of large proportions of resources required for log pre-sorting while still maintaining efficient utilization of the sawing apparatus. In accordance with this alternative approach, log pre-sorting is not performed. Instead, the sawing apparatus is configured to automatically reset itself to one of several possible sawing solution setups in response to control signals transmitted from a control device.

Current log sawing apparatus is capable of automatically changing from one sawing solution setup to another sawing solution setup in response to control signals transmitted from an automatic controller such as a programmable logic computer (PLC) or the like. Because no log pre-sorting is performed in accordance with this alternative prior art method, the logs are fed into the sawing apparatus in random fashion after debarking. That is, the logs are fed into the log sawing apparatus after de-barking without regard to log characteristics.

A sensor is employed and located on the in-feed to the log sawing apparatus, whereby the sensor detects the characteristics of each debarked log that enters the sawing apparatus. After detecting various characteristics of a given log, the sensor transmits to the control device data indicative of the characteristics of the given log. The control device then makes a determination as to the correct sawing solution, and thus the correct sawing apparatus setup, based on the data.

The control device, after determining the correct sawing solution for the given log, then transmits to the sawing apparatus signals that direct the sawing apparatus to do reconfigure itself into the correct sawing solution setup. The sawing apparatus then reconfigures itself to the correct setup, whereupon the given log enters the sawing apparatus and is sawn into lumber pieces in accordance with the correct sawing solution. This process is performed for each and every log that enters the sawing apparatus.

As can be appreciated, such an approach of automatically configuring the sawing apparatus for each log eliminates the need for pre-sorting the logs, and thus eliminates the need for large proportions of resources devoted to such pre-sorting. However, because the logs are randomly fed into the sawing apparatus without regard to diameter, or other such characteristics, and because of the relatively high number of possible setups (about eighteen (18) generally), the sawing apparatus generally must be reconfigured to a different setup between substantially each and every log.

That is, for substantially every log that enters the sawing apparatus for sawing, the sawing apparatus must be reconfigured to a different setup. This reconfiguration of the sawing apparatus from one sawing solution setup to another generally takes about one-half of a second. Additionally, the setup of the sawing apparatus cannot be changed until it is clear of all logs and lumber.

Thus, for a given log requiring a given setup, the sawing setup cannot be changed until the preceding log has cleared the sawing apparatus. This requires an additional time interval of about one-half a second between each successive log that enters the sawing apparatus. Moreover, yet an additional time interval of about one-half of a second is generally required as a “safety buffer” between successive logs in order to avoid stopping and starting incoming logs in the event that the saw is not quite ready to accept the next log.

Thus, the total time interval between each log entering the sawing apparatus is generally approximately one-and-a-half seconds. Thus, if the one-and-a-half second time interval per log could be reduced or eliminated, a significant and beneficial increase in sawing apparatus utilization could be realized as a result. For example, in consideration of a production rate of 10,000 nine-foot long logs during an eight-hour production shift, this one-and-a-half second interval per log translates into an accumulated period of over four hours of idle time for the sawing apparatus.

It is understood that, because the production rate for a given sawing apparatus is directly proportional to the nominal length of the logs sawn, the potential for increase in sawing apparatus utilization resulting from reduction in idle time is variable based on the length of the logs sawn. That is, for logs ranging in length from nine (9) to eighteen (18) feet and ranging in nominal diameters from four (4) and ten (10) inches, the potential production rate increase due to elimination of the time interval between successive logs is anticipated to range from 30% to 100%.

What are needed then are log handling apparatus and methods which achieve the benefits to be derived from similar prior art apparatus and/or methods, but which avoid the shortcomings and detriments individually associated therewith.

### SUMMARY OF THE INVENTION

The present invention, in accordance with various embodiments thereof, provides for apparatus and methods for handling logs. In accordance with one embodiment of the present invention, an apparatus for handling logs comprises an elongated overhead conveyance device along which logs can be conveyed. The apparatus also comprises a bin, and preferably a plurality of substantially parallel bins which are located below the overhead conveyance device. A plurality of logs can be accumulated within each bin.

Incoming logs are scanned, whereby at least one characteristic thereof is detected and measured automatically. The logs are then categorized into one of several groups by comparing the detected characteristic of each log with a set of pre-established criteria. Each group is associated exclusively with a bin, wherein the logs for a group are accumulated within the associated bin.

When a predetermined quantity of logs has been accumulated within any of the bins, the bin is emptied of logs, and that group of logs is fed into the saw for sawing. Since all the logs within a given group are to be sawn in accordance with the same sawing solution, the saw, is able to saw all of the logs within a given group in succession with the same sawing solution setup, thus reducing the prior art time interval gap between successive logs.

In accordance with another embodiment of the present invention, a method of handling logs includes automatically scanning each of a plurality of logs, whereby at least one characteristic of each log is detected and/or measured. The characteristic of each log is then compared to a first range of values and a second range of values to determine if the characteristic falls into either range.

If the characteristic of a given log falls within the first range, the given log is placed into a first group. If the characteristic of the given log falls within the second range, the log is placed into a second group. The logs of the first and second groups are accumulated in this manner, and when the logs of either group accumulate to a predetermined quantity, all of the logs of the respective group are fed into the saw for sawing.

These and other aspects and embodiments of the present invention will now be described in detail with reference to the accompanying drawings, wherein:

### DESCRIPTION OF THE DRAWINGS

FIG. 1 is a side elevation schematic diagram of the apparatus in accordance with one embodiment of the present invention.

FIG. 2 is a partial sectional view of the apparatus that is depicted in FIG. 1.

### DETAILED DESCRIPTION OF THE INVENTION

Apparatus and methods in accordance with various embodiments of the present invention provide for the handling of logs in an efficient manner by sorting and accumulating logs fitting into one of a plurality of groups based on various characteristics of the logs. An apparatus in accordance with one embodiment of the present invention includes at least one bin within which logs having a given, associated sawing solution can be accumulated. Preferably, the apparatus comprises a plurality of such bins, wherein logs are separated into one of several different groups by placing the logs into respective bins.

In accordance with another embodiment of the present invention, each group of logs preferably corresponds to a respective sawing solution. Thus, when a sufficient quantity of logs has accumulated within a given bin, a saw is automatically reconfigured to the sawing solution that corresponds with the given bin, and the logs within the given bin are unloaded therefrom and fed into the saw, thereby allowing the saw to process logs with only a single sawing solution reconfiguration for each bin load of logs. In this manner, the time interval that is defined between each successive log in accordance with one prior art practice can be significantly reduced or eliminated.

It is further understood that the apparatus and method in accordance with various embodiments of the invention can be advantageously employed in conjunction with the sawing of logs, as will become apparent in later discussion. Accordingly, various embodiments of the present invention shall be described and depicted herein with respect to sawing apparatus and sawing operations. However, such description and depiction of sawing apparatus and sawing operations herein is provided only for the purposes of illustrating possible beneficial uses of the present invention. That is, it is understood that the description of the various embodiments of the present invention with respect to sawing apparatus and sawing operations is not intended to limit the present invention in any way to include of any type of sawing apparatus or device, or to be employed in any type of sawing operation.

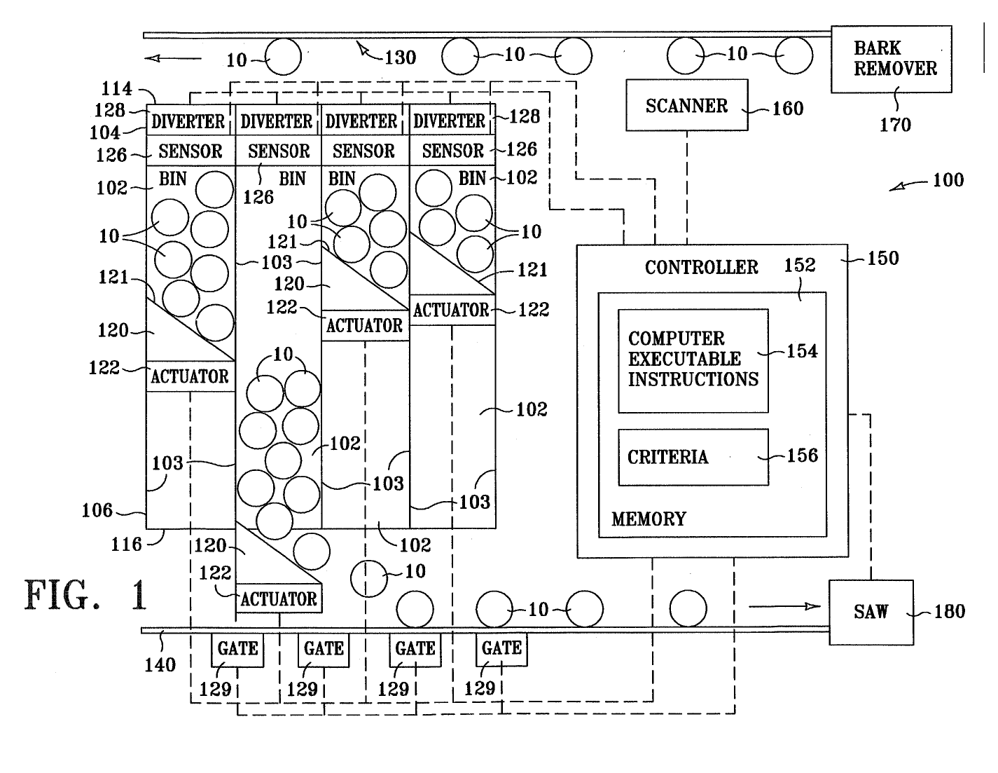

With reference to FIG. 1, a side elevation schematic diagram is shown in which an apparatus 100 for handling logs 10 is depicted in accordance with one embodiment of the present invention. It is understood that, being a schematic diagram, FIG. 1 is intended to illustrate only the basic nature and operation of the apparatus 100, and is thus not intended to portray specific physical or structural aspects of the present invention.

The apparatus 100 comprises a bin 102 in which logs 10 can be placed and accumulated. Preferably the apparatus 100 comprises a plurality of bins 102, as will be explained more fully in later discussion. Preferably, the bin 102 is substantially vertically oriented. That is, the bin 102 is preferably elongated, having an upper end 104 and an opposite and distal lower end 106, wherein the upper end is positioned substantially above and in juxtaposed relation to the lower end. However, it is understood that alternative orientations of the bin 102 can be employed with similar success. For example, the bin 102 can be alternatively oriented so as to be substantially inclined (not shown).

The bin 102 is preferably defined by a plurality of walls 103 which will be discussed below in greater detail. The bin 102 has an upper opening 114 which is preferably defined proximate the upper end 104. The upper opening 114 is configured such that a log 10 can pass there through and into the bin 102. The bin 102 also has a lower opening 116 that is preferably defined proximate the lower end 106. The lower opening is configured such that a log 10 can pass there through and out of the bin 102.

The apparatus 100 preferably comprises a carriage 120 that is operatively supported within the bin 102. The carriage 120 is configured to move longitudinally within the bin 102. That is, the carriage 120 is preferably configured to move substantially between the upper end 104 of the bin 102 and the lower end 106 of the bin, and vice versa. The carriage 120 is configured to support thereon at least one log 10 within the bin 102. That is, preferably, the carriage 102 is configured to support the weight of at least a portion of the logs 10 as the logs accumulate within the bin.

More preferably, the carriage 120 is configured to support the weight of a plurality of logs 10 within the respective bin 102, wherein the logs are supported by the carriage. That is, the carriage 120 is preferably configured to support a plurality of logs 10 thereon and to contain the logs there above, in conjunction with the walls 103. The carriage 120 is preferably configured to move incrementally downward within the bin 102 as logs 10 accumulate therein and above the carriage. That is, as a group of logs 10 accumulate within the bin 102, the carriage 120 preferably moves downward in proportion to the increase in the number of logs of the group.

One purpose of causing the carriage 120 to move incrementally downward in proportion to the number of logs 10 in the bin 102, is to maintain the uppermost logs in a position substantially proximate the upper opening 114 of the bin 102. By maintaining the uppermost logs 10 in a position substantially proximate the upper opening 114, the log which enter there through need only fall a minimum distance before coming to rest on either the carriage 120 or the uppermost logs supported thereon. In such a manner, the probability of damage to the logs 10 and/or jamming of the logs within the bin 102 is reduced.

The carriage 120 is preferably configured to allow the logs 10 which are supported there above and within the bin 102 to be released therefrom and through the lower opening 116 when the carriage is moved proximate its lowermost position relative to the bin. Accordingly, the carriage 120 preferably defines a surface 121 which is configured to contact at least one log 10 supported by the carriage, wherein the surface is inclined relative to the bin 102 as shown. This aspect of the present invention will be explained in greater detail in later discussion.

The apparatus 100 preferably comprises an actuator 122 that is operatively connected to the carriage 120. The term “actuator” as used herein means a mechanism that is configured to selectively move the carriage 120 in a longitudinal direction relative to the bin 120, and substantially between the upper end 104 thereof and the lower end 106 thereof, and to place the carriage in a predetermined position relative to the upper and lower ends of the bin. The actuator 122 can comprise any of a number of known actuating means, including hydraulic cylinders, jack screws, rack and pinion gears, and the like.

The apparatus 100 preferably comprises a sensor 126 that is preferably positioned proximate the upper end 104 of the bin 102. The sensor 126 is preferably configured to detect the presence of a log 10 proximate the upper end 104 of the bin 102. More specifically, the sensor 126 is preferably configured to detect the presence of a log 10 near the upper end 104 of the bin 102 so as to facilitate the identification of the uppermost log of the logs within the bin. That is, the sensor 126 is preferably configured to detect the top of a group of logs within the bin 102. This aspect of the apparatus 100 will be more fully explained in later discussion.

As is further seen in FIG. 1, the apparatus 100 preferably comprises an overhead conveyance device 130 that is located substantially above the bin 102. The overhead conveyance device 130 is configured to convey there along at least one log 10, and preferably a plurality of logs. The overhead conveyance device 130 is preferably substantially horizontally oriented. The overhead conveyance device 130 is also preferably configured so that logs 10 conveyed there along can be selectively released there from and dropped into the bin 102, as will be discussed in greater detail below.

In order to facilitate the selective release of predetermined logs 10 from the overhead conveyance device 130, a diverter device 128 is preferably included in the apparatus 100 and is preferably operatively located proximate the upper opening 114 of the bin 102. The diverter device 128 is configured to be selectively operated, whereby such operation thereof causes a given log 10 to be released from the overhead conveyance device 130, whereupon the given log proceeds there from and into the bin 120 through the upper opening 114 thereof.

The apparatus 100 also preferably comprises an under-slung conveyance device 140. The under-slung conveyance device 140 is located substantially below the bin 102, and is preferably substantially horizontally oriented. The under-slung conveyance device 140 is configured to convey there along at least one log 10, and preferably a plurality of logs. The under-slung conveyance device 140 is configured so that logs 10 can be released from the bin 102 through the lower opening 116 thereof, whereupon the logs are deposited onto the under-slung conveyance device and carried away from the bin.

The apparatus 100 also preferably comprises a gate device 129 that is operatively located proximate the lower opening 116 of the bin 102. The gate device 129 is configured to be selectively operated, whereby the flow of logs 10 out of the bin 102 and through the lower opening 116 is substantially controlled. That is, the gate device 129 is configured to be selectively operated so as to facilitate the controlled exit of logs 10 from the bin 120 through the lower opening 116.

Specifically, one purpose of the gate device 129 is to control the deposition of the logs 10 onto the under-slung conveyance device 140 as the logs exit the bin 102 through the lower opening 116 under the force of gravity. That is, the gate device 129 is configured to function in a complimentary manner with respect to the inclined nature of the surface 121 so as to facilitate an orderly exit of the logs 10 from the bin 102, and more preferably, to facilitate the placement of the logs upon the under-slung conveyance device 140 in a substantially orderly, and spaced manner. The gate device 129 will be explained in greater detail in later discussion.

As is further seen from a study of FIG. 1, the apparatus 100 can include a scanner 160. The scanner 160 is preferably located in a position relative to the path of the logs 10 as the logs approach the bin. For example, the scanner 160 can be positioned so as to scan logs 10 as the logs are conveyed along the overhead conveyance device 130. Alternatively, the scanner 160 can be positioned so as to scan the logs 10 as the logs are conveyed along another conveyance means not shown in FIG. 1, and which is upstream of the bin 102.

In any case, the scanner 160 is configured to scan logs 10 before the logs reach the diverter device 128. The term “scanner” as used herein means a device that is configured to detect at least one characteristic of a log 10 as the log passes the scanner. Scanners are known in the art and can be employed to detect log characteristics such as diameter, curvature, sweep, cross-sectional area, and the like. Thus, the scanner 160 is configured to scan each log 10, and thereby detect at least one characteristic of each log. Preferably, the scanner 160 detects a plurality of predetermined characteristics of each log 10 before the log reaches the bin 102.

The apparatus 100 can also include a bark remover 170. Bark removers are known in the art and are employed to automatically remove the bark from a log 10 in preparation for sawing of the log. Additionally, the apparatus 100 preferably comprises a saw 180. Preferably, the saw 180 is capable of automatically reconfiguring itself to any of a plurality of setups in response to a control signal, wherein each setup corresponds to a unique sawing solution. Such saws are known in the art and have been briefly discussed above, along with the concept of a sawing solution, with respect to the prior art.

A further study of FIG. 1 reveals that the apparatus 100 preferably comprises a controller 150. The controller 150 is configured to control various aspects of the apparatus 100 by way of receiving data signals, transmitting control signals, and processing data, as will be explained in the following discussion. Controllers are known in the art and generally employ various decision-making, and computational devices such as digital processors (not shown) and the like. The controller 150 preferably includes a memory device 152. Memory devices are also known in the art and are generally incorporated into controllers to facilitate the operation thereof.

A series of computer executable instructions 154 is also preferably included in the apparatus 100, as is a set of criteria 156. Preferably, the series of computer executable instructions 154 and the set of criteria 156 are operatively stored within the memory device 152 of the controller 150. The function of the controller 150, as well as that of the series of computer executable instructions 154 and the set of criteria 156, will be discussed in greater detail below.

The controller 150 is preferably communicably linked with the diverter device 128. The term “communicably linked” as used herein means linked by way of known signal transmission means which can include electrical wire means, fiber optic means, radio transmission means, sonic transmission means, infrared transmission means, and the like. That is, when two devices are described herein to be communicably linked, it is understood to mean that data signals can be transmitted from one object and received by the other object by way of signal transmission means, and vice versa.

Thus, in the case wherein the controller 150 is communicably linked with the diverter device 128, the controller can selectively operate the diverter device by way of control signal transmission. That is, the controller 150 can send a control signal to the diverter device 128 which is received thereby, and which instructs the diverter device to operate in a predetermined manner. Likewise, the controller 150 is preferably communicably linked with the actuator 122, whereby the actuator can be selectively operated by the controller. In yet another similar manner, the gate device 129 is preferably communicably linked with the controller 150, whereby the controller can selectively operate the gate device.

The controller 150 is also preferably communicably linked with the sensor 126 and/or the scanner 160 and/or the saw 180. In this manner, the controller 150 can receive data signals from the sensor 126, and/or can also receive data signals from the scanner 160. The communicable linkage of the controller 150 and the saw 180 enables the controller to control various operational aspects of the saw, such as instructing the saw to reconfigure itself to a given sawing solution setup.

Still referring to FIG. 1, it is seen that the apparatus 100 preferably comprises a plurality of bins 102. In such a case, wherein the apparatus 100 comprises a plurality of bins 102, the apparatus also preferably comprises a respective actuator 122 and/or a respective sensor 128 and/or a respective diverter device 128 for each of the bins as shown. That is, preferably, each bin 102 has a corresponding carriage 120, actuator 122, sensor 128, and diverter device 128. As is seen, the bins 102 are preferably oriented in a substantially parallel manner relative to one another.

As mentioned above, the saw 180 is preferably capable of reconfiguring to one of several sawing solution setups to facilitate the efficient production of lumber in view of varying characteristics of the logs 10 to be sawn. Accordingly, as will become more apparent in later discussion, the number of bins 102 is preferably at least equal to the number of sawing solution setups employed in conjunction with the operation of the apparatus 100.

More preferably, as will also become apparent in later discussion, the number of bins 102 is greater than the number of sawing solution setups employed in conjunction with the apparatus 100. As is mentioned above with respect to the prior art, a typical number of sawing solution setups is about eighteen for logs ranging in diameter from four to ten inches. Thus, in such a case, the apparatus 100 preferably includes eighteen bins 102, but more preferably the number of bins included in the apparatus is twenty. That is, most preferably, the number of bins is two more than the number of sawing solutions employed by the associated sawing apparatus 180.

In accordance with a typical operational scheme of the apparatus 100, a supply of logs 10 to be sawn is continually fed in succession through the bark remover 170, whereby the bark is removed from each of the logs. The logs 10 proceed toward the bins 102 by way of a conveyance means, such as the overhead conveyance device 130. It is understood that one or more intermediate conveyance means (not shown) can be employed between the bark remover 170 and the overhead conveyance device 130.

While being conveyed from the bark remover 170 to the bins 102, each of the logs 10 passes the scanner 160. The scanner 160 scans each log 10 as the logs pass the scanner. During the scan of each log 10, the scanner 160 detects one or more characteristics of each log. As mentioned above, these characteristics can include such data as the diameter, cross-sectional area, sweep, curvature, and the like. Preferably, the scanner 160 detects a plurality of characteristics of each log 10. After detecting the characteristics of each log 10, the scanner 160 transmits the characteristics, in the form of data signals, to the controller 150.

The controller 150 receives the data signals from the scanner 160. The controller 150 preferably assigns a unique identifier, or the like, to each log 10. The controller 150 also preferably tracks the relative position of each log 10 and associates the relative position and the characteristics of each log to the corresponding identifier. In other words, once a given log 10 passes the scanner 160, the controller 150 preferably has identified the given log and is tracking the position of the log as it moves toward the bins 102. The controller 150 also preferably “knows” the associated characteristics of the given log 10, which have been stored in the memory device 152.

As briefly mentioned above, the set of criteria 156 is contained in the controller 150. The set of criteria 156 is accessible by the series of computer executable instructions 154. The set of criteria 156 comprises a set of values which correspond to the range of sawing solutions to be employed for sawing the logs. That is, the series of computer executable instructions 154 compares the characteristics of each log 10, as detected by the scanner 160, to the set of criteria 156, which results in a determination of the sawing solution to be used for each log.

This process of determining the sawing solution for each log, as performed by the controller 150, is known in the art. Generally, the number of various characteristics employed in determining the sawing solution for a given log is directly proportional to the accuracy and/or precision with which the sawing solution is applied. Thus, as briefly mentioned above, several characteristics such as diameter, shape, sweep, curvature, and the like, are preferably considered in the determination of the sawing solution for each log 10.

Still referring to FIG. 1, the controller 150 is preferably configured to assign a unique identifier to each bin 102, and also to assign one each of the sawing solutions to one of the bins. That is, each sawing solution is preferably exclusively associated with at least one corresponding bin 102. However, more preferably, as will become more apparent in later discussion, the assignment of a sawing solution to a particular bin 102 is done only on a temporary basis, in accordance with the random availability of the bins. In other words, sawing solutions are assigned and reassigned to bins 102 on an “as-required” basis, without regard to relative locations of the bins. This concept will become more apparent upon further understanding of the operation of the apparatus 100.

Thus, as a given log 10 approaches the bins 102 on the overhead conveyance device 130, the controller 150 determines, by way of the series of computer executable instructions 154, which bin the given log will be placed based on the characteristics of the given log as compared with the set of criteria 156. When the given log 10 is properly positioned above the proper bin 102, as determined by the controller 150, a control signal is transmitted from the controller to the respective diverter device 128 associated with the proper bin. The diverter device 128 receives the signal from the controller 150 and is thereby operated so as to cause the given log 10 to be released from the overhead conveyance device 130, whereupon the log proceeds into the associated bin 102 through the respective upper opening 114 thereof.

However, before the first log 10 is caused to enter the associated bin 102 in the manner described above, the controller 150 sends a signal to the respective actuator 122 so as to cause the actuator to move the corresponding carriage 120 to its uppermost position within the bin. In this manner, the first log 10 which enters the bin falls a minimum distance and comes to rest upon the surface 121. Subsequent logs 10 are assigned to the appropriate bin 102 in a like manner and come to rest upon one another within the bin.

As mentioned briefly above, a respective sensor 126 is preferably operatively located proximate the upper end 104 of each bin 102. The sensor 126 is also preferably configured to detect the presence of a log 10. When the sensor 126 detects the presence of a log 10, the sensor transmits a signal which is received by the controller 150, wherein the signal is indicates the presence of a log. In response to receiving such a signal, the controller 150 preferably directs the associated actuator 122, by way of data signal transmission, to move the respective carriage 120 downward and toward the respective lower end 106.

The actuator 122 continues to move the respective carriage 120 downward until the controller 150 receives from the sensor 126 a signal indicating that the presence of a log 10 is no longer detected. Upon receipt of such a signal, the controller 150 then signals the associated actuator 122 to stop the movement of the respective carriage 120, whereupon the carriage remains stationary until the actuator is again directed by the controller to move the carriage. In this manner, the uppermost log 10 within a given bin 102 is maintained at a position substantially proximate the upper end 104 of the given bin.

More preferably, a pair of sensors 126 is operatively located proximate the upper end 104 of each bin 102, wherein each of the pair of sensors is located at opposite ends of the bin. That is, in such a case, each one of the pair of sensors 126 is located so as to detect an associated end of a given log 10 within the respective bin 102. In this manner, an uneven orientation of the uppermost log 10 within a given bin 102 can be detected. For example in the case wherein a pair of sensors 126 is employed, if one sensor detects the presence of a log 10 while the other sensor does not detect the presence of a log, an uneven orientation of the uppermost log within a given bin can be indicated.

Such an uneven orientation of a log 10 within a bin 102 can be the result of one of a number of conditions, including jamming or binding of the logs within the bin, or the anomalous buildup of log taper. The term “anomalous buildup of log taper” refers to the “tilting” of a pile of logs 10 as the result of a majority of the logs within the pile being similarly oriented with regard to the natural log taper. That is, if a majority of logs 10 within a given bin 102 are oriented similarly with regard to log taper, then the uppermost log will become more and more inclined as the number of logs within the bin increases. However, because the logs 10 are preferably randomly oriented in a given bin 102 with regard to taper, such tilting of the log pile within the bin is generally an anomaly.

Other alternative methods can also be employed for detecting such an uneven orientation of a log, or logs, within a bin 102. For example, one such alternative method is to detect and measure the sum of the cross-sectional areas of both ends of the logs 10 within a bin 102. The sums of the cross-sectional areas can then be compared with one another, wherein a significant difference can indicate an anomalous buildup of log taper. If an anomalous buildup of log taper is detected within a given bin 102, the logs 10 within the given been are preferably removed from the bin in the manner described below.

When the quantity of logs 10 within a given bin 102 accumulates to a predetermined level, or if some other condition so warrants, as in the case of an anomalous buildup of log taper, the logs are preferably released from the associated bin in order to minimize the probability of jamming and the like as the result of such a condition. When released from the bin 102, the logs 10 are preferably deposited onto the under-slung conveyance device 140. Once deposited on the under-slung conveyance device 140, the logs 10 eventually arrive at the saw 180 to be sawn into lumber pieces (not shown). It is understood that one or more intermediate conveyance means can be employed between the under-slung conveyance device 140 and the saw 180.

The quantity of logs 10 within a given bin 102 can be determined by any of a number of known means. For example, the relative position of the carriage 120 can be employed to indicate the approximate quantity of logs 10 within a given bin 102. For example, as logs 10 accumulate within a given bin 102, and when the carriage 120 reaches a predetermined location proximate the lower end 106 of the given bin, an approximate quantity of logs can be known to exist within the given bin.

When a predetermined quantity of logs 10 is detected to exist within a bin 102, the controller 150 is preferably configured to initiate a “bin unload sequence.” Such a bin unload sequence can include moving the respective carriage 120 to its lowermost position, thereby allowing the logs 10 within the bin to move under the force of gravity through the lower opening 116 and onto the under-slung conveyance device 140.

Preferably, the surface 121 of the carriage 120 is inclined as mentioned above so as to direct the logs 10 generally in an intended direction of movement as the logs exit the bin 102 by way of passage through the respective lower opening 116. The bin unload sequence can also include selective operation of the respective gate device 129 which has been briefly discussed above. The function of the gate device 129 will become more apparent in later discussion relating to its physical configuration.

It is thus appreciated that the apparatus 100 can be beneficially employed in log sawing operations, wherein employment of the apparatus results in increased saw utilization rates in comparison with prior art methods and apparatus, while also eliminating the need for prior-art log pre-sorting processes. Specifically, the apparatus 100 can be employed to automatically accumulate groups of logs 10 within respective bins 102, wherein each group of logs has only a single sawing solution setup associated therewith.

In this manner, groups, or slugs, of logs all having the same sawing solution can be successively released from the associated bin 102 and fed into the saw 180. The saw 180 can thus process an entire slug of logs with a single sawing solution. In other words, an entire slug of logs can be sawn without changing the sawing solution setup of the saw 180. This, in turn, means that the logs can be processed at a significantly higher rate than in accordance with prior art methods because the “gap” or time interval between each successive log in a given slug can be minimized or reduced.

When employing the apparatus 100 of the present invention, the sawing solution setup of the saw 180 need be reconfigured only once for each slug of logs 10 which are sawn. In other words, the sawing solution setup of the saw 180 is preferably reconfigured once each time a bin 102 is unloaded onto the under-slung conveyance device 140. Thus, rather than occurring between substantially every successive log entering the saw 180, the second-and-a-half “gap” or time interval occurs only once between each group of logs.

Still referring to FIG. 1, as logs 10 accumulate within the plurality of bins 102 as described above, the first “full” slug of logs to accumulate is unloaded from the respective bin and deposited onto the under-slung conveyance device 140 from whence the logs of this first slug proceed to the saw 180 for sawing in accordance with a first sawing solution. While this first slug of logs 10 is being sawn, a second “full” slug of logs accumulates, and this second slug of logs is unloaded from the respective bin 102 and deposited onto the under-slung conveyance device 140 in a like manner.

However, as explained above, a sufficient “gap” is left between the first slug and the second slug so that the saw 180 has time to reconfigure itself to a second sawing solution setup, in accordance with which the second slug is sawn. It is important to note that, as the logs 10 of a given slug, which are associated with a given sawing solution, are unloaded from the respective bin 102, the logs which are approaching the bins on the overhead conveyance device 130, and which area also associated with the given sawing solution, are reassigned to the first available empty bin.

Furthermore, if a bin 102 associated with a given sawing solution becomes full and cannot be emptied immediately, an available empty bin is assigned to the sawing solution so that incoming logs associated with that sawing solution can be placed therein to avoid a stoppage of incoming logs. Thus, it is possible that two bins 102 are simultaneously associated with a given sawing solution during the unloading of a bin.

Preferably, logs 10 are substantially continuously sorted and accumulated by placement thereof into one of the bins 102 by way of operation of the diverter device 128 in conjunction with the controller 150, the scanner 160, and related components as described above. Additionally, a substantially constant supply of logs 10 is preferably provided by the plurality of bins 102 by way of operation of the gate device 129 and the carriage 120 in conjunction with the controller 150 and related components so as to result in the successive release from the bins of respective slugs of logs which have previously accumulated therein, as also explained above. The above-mentioned processes of sorting, accumulating and releasing the logs 10 are preferably performed in a substantially simultaneous fashion.

Thus, when the apparatus 100 includes a sawing apparatus 180, the logs 10 which are associated with a given sawing solution are not generally fed into the saw for sawing until a “full” slug of logs has accumulated within an associated bin 102. As a result, a substantially continuous supply of logs 10 can be fed into the sawing apparatus 180, wherein the sawing solution setup need only be reconfigured between each slug of logs. Thus, a significant “gap” for sawing solution reconfiguration need only be provided between each successive slug, wherein the gap between each log within a given slug can be minimal or substantially eliminated.

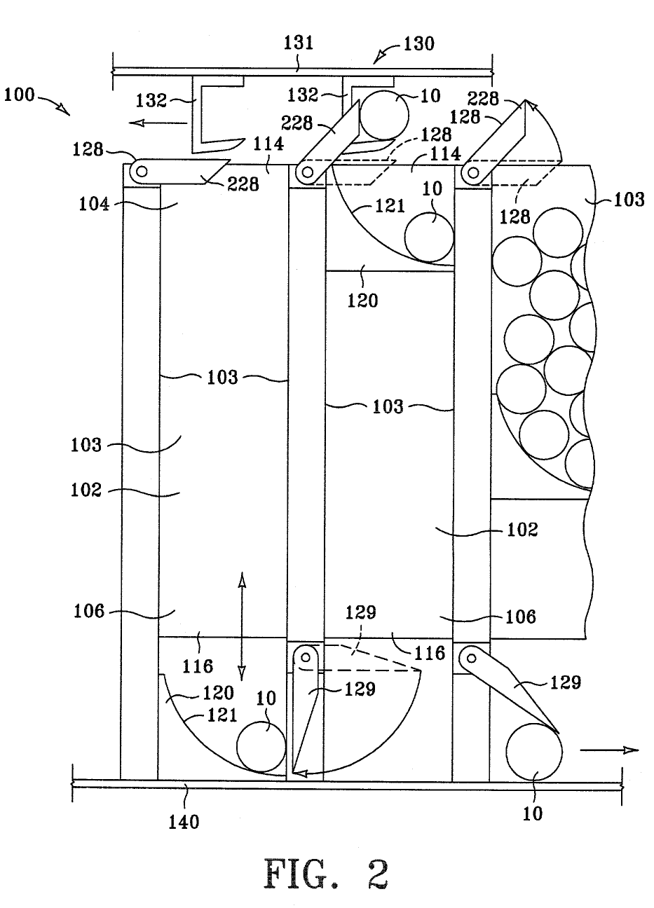

Moving now to FIG. 2, the apparatus 100 of FIG. 1 is depicted in a side elevation partial sectional view. As is seen, the overhead conveyance device 130 preferably includes a driven member 131, such as a conveyor chain or the like. The overhead conveyance device 130 also preferably includes a plurality of lugs 132 that are supported on the driven member 131 at regular, spaced intervals. Each of the lugs 132 are configured to support thereon a log 10 for conveyance in the general direction indicated by the respective arrow as shown.

As mentioned above, each bin 102 preferably comprises a set of walls 103. The walls 103 are preferably substantially vertically oriented, wherein the surface of each wall is substantially vertical. One purpose of the walls 103 is to contain the logs 10 within the respective bin. Accordingly, the walls 103 can be solid, or in the alternative, can be perforated or the like. Furthermore, it is understood that the walls 103 can be configured in one of a number of alternative manners.

For example, the walls 103 can comprise a plurality of substantially horizontally oriented, parallel bars or the like. Preferably, the walls 103 are configured in a substantially smooth manner, such that the logs 10, while moving through the bin 102, will be less likely to snag or bind on the walls. The walls 103 are more preferably fabricated from substantially durable sheet or plate material such as steel or the like.

The diverter device 128 preferably comprises a diverter member 228 that is pivotally mounted on the respective bin 102. The diverter device 128 also preferably comprises a motive device (not shown) that is operatively connected to the diverter member 228, wherein the motive device is configured to cause the diverter member to pivot relative to the bin 102. The diverter member 228 is preferably configured to pivot between a retracted position and an extended position as shown.

When in the retracted position, the diverter member 228 allows the logs 10 to pass there over while being conveyed on the overhead conveyance device 130. However, when in the extended position, the diverter member 228 contacts a given log 10 as the given log is supported on a respective lug 132. The movement of the lug 132 in the direction indicated by the respective arrow by operation of the driven member 131 causes the given log 10 to be stripped from the lug as the result of the contact between the moving lug and the stationary, extended diverter member 228.

Once stripped from the lug 132 in such a manner, the log 10 can fall downward under the force of gravity and into the bin 102, coming to rest upon the surface 121 of the carriage 120 or upon a previous log. After removing the selected log 10 from the respective lug 132, the diverter member 228 is preferably moved to its retracted position so as to allow other logs to pass the bin without being released from the conveyance device 130.

The gate device 129, mentioned briefly above, is located proximate the lower end 106, and is also preferably pivotally mounted to the respective bin 102 as shown. A respective motive source (not shown) is also preferably included in the apparatus 100 for the purpose of moving the gate device 129 between a fully extended position and a fully retracted position. When in the fully retracted position, the gate device 129 is preferably substantially horizontal as depicted in FIG. 2.

Conversely, when in the fully extended position, the gate device 129 is preferably substantially vertical as is also depicted in FIG. 2. It is seen that, when the gate device 129 is fully extended, it functions as an extension of the walls 103 when the carriage 120 is lowered to a position proximate the lower end 106. That is, when the gate device 129 is in the fully extended position and when the carriage 120 has moved to its substantially lowermost position relative to the bin 102, the logs 10 within the bin are contained therein by the gate device. Preferably, a set of stops (not shown) or the like are employed to limit movement of the gate device 129, wherein the gate device is configured to impinge against a respective stop at both the fully extended and fully retracted positions.

The motive source (not shown) that is so employed to move the gate device 129 is preferably configured to act as a resilient biasing member with respect to the gate device when the gate device is in the extended position. That is, the gate device 129 is preferably configured to pivot resiliently in response to external forces applied thereto as the result of contact with logs 10 which are exiting the bin 102 in order to facilitate a controlled release of the logs from the bin, as will be more fully explained below.

For example, the motive source employed for moving the gate device 129 can be a two-way pneumatic or hydraulic actuator (not shown) for which the fluid pressure can be regulated between relatively low pressures and relatively high pressures. When the logs 10 are accumulating in a given bin, the associated gate device 129 is preferably stowed in its fully, retracted position by application to the gate device of a relatively small force in a first direction.

When a determination has been made to allow the logs 10 to be released from the bin 102, the gate device 129 is preferably caused to move from the fully retracted position to the fully extended position by application of a force to the gate device in a second direction that is opposite the first direction. The extension of the gate device 129 is preferably performed before the carriage 120 begins to descend within the bin 102. When the gate device 129 reaches the fully extended position, a relatively large force is applied to the gate device in the second direction in order to prevent the gate device from moving away from the fully extended position in response to forces exerted thereon by the logs 10.

Also, after the gate device 129 has reached its fully extended position, the carriage 120 is preferably caused to lower to its lowermost position relative to the bin. When the carriage 120 reaches its lowermost position, at least a portion of the logs 10 supported there above will preferably be caused to bear against the fully extended gate device 129 as a result of the inclined orientation of the surface 121.

The force holding the gate device 129 in the fully extended position is now preferably lowered so as to allow resilient movement of the gate device away from its fully extended position. That is the force with which the gate device 129 is held in the fully extended position is preferably eased so that force of the logs 10 bearing against the gate device causes the gate device to yield by moving slightly away from the fully extended position, and thereby allowing the logs to be controllably released from the bin.

For example, in the case wherein a pneumatic actuator (not shown) is employed to move the gate device 129, the fluid pressure within the actuator can be lowered so as to be compressed by the force of the logs 10 bearing against the gate device, thereby allowing resilient movement of the gate device. In such a manner, the gate device 129 can be advantageously employed to “throttle” the flow of logs 10 from the bin 102, so as to facilitate controlled movement of the logs under the force of gravity.

Still referring to FIG. 2, it is seen that the surface 121 of the carriage 120 is preferably inclined as mentioned above. Such an inclined configuration of the surface 121 can facilitate controlled movement of the logs 10 as the logs exit the respective bin 102 through the lower opening 116. That is, specifically, the inclined configuration of the surface 121 can serve to direct the flow of logs 10 as the logs exit the bin 102. As is further seen, the surface 121 is preferably concave, and is also preferably arcuate. Most preferably, the surface 121 is inclined, arcuate, and concave.

In accordance with another embodiment of the present invention, a method of sawing logs comprises defining a first range of values for a given log characteristic. That is, in the case wherein the given log characteristic is the diameter of a log, for example, the first values can range from eight inches to eight and one-half inches. A first sawing solution can be associated with the first range of values. In other words, the logs for which the given characteristic falls within the first range can be sawn most efficiently by using the first sawing solution.

Likewise, a second range of values can be defined for the given log characteristic, wherein the first range of values and the second range of values are preferably mutually exclusive with respect to one another. For example, in view of the example given above, the second values can range from eight and one-half inches to nine inches. A second sawing solution is associated with the second range of values. Once the first range of values and the second range of values have been defined, and the first and second sawing solutions associated therewith, respectively, each of a plurality of logs can be automatically scanned, whereby such scanning determines the respective value of the characteristic for each log.

The method includes determining whether the value of the characteristic of each log falls within the first range of values or within the second range of values. For example, as the result of scanning a given log, it is determined that the diameter of the log is eight and one-quarter inches. Because the diameter of the given log is eight and one-quarter inches, it is thus determined that the characteristic of the given log falls within the first range of values.

Alternatively, the value of the characteristic for a given log may not fall within either the first range of values or the second range of values. For example, it may be determined that the diameter of the log is seven inches, in which case the value of the characteristic of the given log falls neither in the first or second ranges. However, if the value of the characteristic for a given log falls within the first range, the log is placed into a first group. Likewise, if the value of the characteristic for any given log falls within the second range, the log is placed into a second group.

Logs are preferably accumulated in this manner in both the first group and the second group. The method further includes detecting that a predetermined quantity of logs has accumulated in the first group. Once the predetermined quantity of logs has been detected in the first group, all of the logs of the first group are sawn in accordance with the first sawing solution. Likewise, the detection of a predetermined quantity of logs in the second group leads to the sawing of all the logs in the second group in accordance with the second sawing solution.

The method can also include providing a first bin and a second bin. Each of the first and second bins can be configured in the manner of the bin 102 described above with respect to the prior art. The logs of the first group are preferably automatically accumulated in the first bin, while the logs of the second group are preferably automatically accumulated in the second bin. When a predetermined quantity of logs is accumulated and detected, the logs are preferably released from the associated bin for sawing.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A log handling apparatus, comprising:
an elongated overhead conveyance device along which logs can be conveyed; and,
a plurality of substantially parallel log bins located below the overhead conveyance device, and in each of which bins a plurality of logs can be accumulated, each bin comprising:
a set of substantially vertically oriented walls;
an upper opening defined by the walls, and through which upper opening a log can pass;
a lower opening defined by the walls, and through which lower opening a log can pass;
a diverter device operatively supported on the bin proximate the upper opening, and which diverter device can be selectively operated, whereby such operation causes a pre-selected log to be diverted from the overhead conveyance device and deposited into the bin through the upper opening;
a carriage movably supported within the respective bin, whereby the carriage is selectively movable substantially between the upper opening and the lower opening, and whereby logs within the respective bin are movably supported on and above the carriage.

2. The apparatus of claim 1, and further comprising an elongated under-slung conveyance device along which logs can be conveyed, and which under-slung conveyance device is located substantially below the plurality of bins, whereby selective positioning of a given carriage proximate the respective lower opening allows the logs within the respective bin to pass through the lower opening, and whereby the logs are deposited onto the under-slung conveyance device.

3. The apparatus of claim 2, and further comprising a log scanner capable of scanning each log prior to removal thereof from the overhead conveyance device, whereby such scanning determines at least one characteristic of each log, in accordance with which characteristic the respective log is placed into a given bin.

4. The apparatus of claim 3, and further comprising a saw, into which saw the logs can be fed after being deposited onto the under-slung conveyance device.

5. The apparatus of claim 4, and wherein the diverter device comprises an arm pivotally supported on the bin.

6. The apparatus of claim 5, and wherein each bin further comprises a gate device operatively supported on the bin proximate the lower opening, and which gate device can be selectively operated, whereby such operation facilitates control of the flow of logs while exiting the bin through the lower opening.

7. A log handling apparatus, comprising:
a substantially elongated and vertically-oriented bin in which a plurality of logs can be accumulated, and wherein the bin has an upper end and an opposite, distal lower end; and,
a carriage operatively disposed within the bin, wherein the carriage is movable between the upper end and the lower end, and wherein logs within the bin are supported by the carriage.

8. The apparatus of claim 7, and further comprising an actuator operatively connected to the carriage, wherein operation of the actuator causes movement of the carriage relative to the bin.

9. The apparatus of claim 8, and further comprising a diverter device operatively supported on the bin proximate the upper end thereof, wherein pre-selected logs are diverted into the bin by selective operation of the diverter device.

10. The apparatus of claim 9, and further comprising a gate device operatively supported on the bin proximate the lower end thereof, wherein movement of logs out of the bin is controlled by selective operation of the gate device.

11. The apparatus of claim 7, and further comprising a surface defined on the carriage, wherein:
at least one log within the bin contacts the surface and is supported thereon; and, the surface is inclined.

12. The apparatus of claim 11, and wherein the surface is substantially concave.

13. The apparatus of claim 12, and wherein the surface is substantially arcuate.

14. A log handling apparatus, the apparatus comprising:
a bin in which a plurality of logs can be accumulated;
a controller;
a scanner communicably linked with the controller and configured to detect a characteristic of a given log before the log enters the bin;
a diverter device communicably linked with the controller; and,
a series of computer executable instructions operatively contained within the controller and configured to selectively operate the diverter device in response to detection by the scanner of the characteristic of the given log, thereby causing the given log to enter the bin.

15. The apparatus of claim 14, and further comprising:
a sensor communicably linked with the controller and configured to detect the presence of a log;
a carriage operatively disposed within the bin; and,
an actuator operatively connected to the carriage and communicably linked with the controller, whereby the series of computer executable instructions is further configured to selectively operate the actuator in response to detection by the sensor of the presence of a log.

16. The apparatus of claim 14, and further comprising a gate device communicably linked with the controller, whereby the series of computer executable instructions is further configured to selectively operate the gate device, thereby facilitating control of the flow of logs exiting the bin.

17. The apparatus of claim 14, and further comprising a saw communicably linked with the controller, wherein the saw is adjustable to one of a number of sawing solution setups, and wherein a given sawing solution setup is determined by the set of computer executable instructions and sent to the saw in response to the characteristic detected by the scanner.

18. A log handling method, comprising:
defining a first range of values for a given characteristic;
associating a first sawing solution with the first range of values;
defining a second range of values for the given characteristic;
associating a second sawing solution with the second range of values;
automatically scanning each of a plurality of logs, whereby such scanning determines the respective characteristic for each log;
determining whether the characteristic of each log falls within the first range or the second range;
placing a given log into a first group if the respective characteristic falls within the first range;
placing the given log into a second group if the characteristic falls within the second as range;
accumulating logs within the first and second groups;
detecting that a predetermined quantity of logs has accumulated in the first group; and,
sawing all of the logs of the first group in accordance with the first sawing solution.

19. The method of claim 18, and further comprising:
detecting that a predetermined quantity of logs has accumulated in the second group; and,
sawing all of the logs of the second group in accordance with the second sawing solution.

20. The method of claim 19, and further comprising:
providing a first bin; and,
providing a second bin, wherein:
the logs of the first group are automatically accumulated within the first bin; and,
the logs of the second group are automatically accumulated within the second bin.
